(19) United States
(12) Patent Application Publication
(10) Pub. No.: US 2005/0013993 A1
(43) Pub. Date: Jan. 20, 2005

(54) Environmental & thermal barrier coating

(75) Inventors: Chien-Wei Li, Livingston, NJ (US); Derek Raybould, Denville, NJ (US); Bjoern Schenk, Phoenix, AZ (US); Thomas E. Strangman, Prescott, AZ (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 10/621,719

(22) Filed: Jul. 16, 2003

(51) Int. Cl. B32B 9/04

(52) U.S. Cl. 428/336; 428/446; 428/701; 428/702; 428/699; 428/697; 416/241 B; 427/446; 427/248.1

(57) ABSTRACT

An environmentally and thermally protected component comprising a silicon-based ceramic or composite substrate and an environmental and thermal barrier coating disposed on the substrate. The environmental and thermal barrier coating comprises at least about 50 mole % AlTaO₄. The composition of the environmental and thermal barrier coating may be adapted to provide excellent CTE (coefficient of thermal expansion) match with a substrate, such as a SiC-based ceramic or composite. Coating compositions of the invention have a stable crystalline structure at a temperature up to at least about 1550° C. Methods for preparing an environmentally and thermally protected component are also disclosed.

### BACKGROUND OF THE INVENTION

The present invention generally relates to an environmental and thermal barrier coating, and to a component coated with such a coating. The present invention also relates to methods for preparing an environmental and thermal barrier coating, and for preparing a component coated with such a coating.

Advanced turbomachines use silicon-based (Si-based) non-metallic materials such as silicon nitride, silicon carbide, molybdenum silicides, niobium silicides, and their composites for hot-section components. Due to the high temperature capability of Si-based ceramics, those ceramic turbomachines operate at higher temperatures with minimum cooling and higher engine performance. However, at operating temperatures above about 1200° C., Si-based ceramics can be adversely affected by oxidation and water vapor present in the flow stream. Such hostile engine environments result in rapid recession of Si-based ceramics parts. Recession refers to the wear of a substrate or component due to the effects of ablation and/or erosion due to particulate impact.

In U.S. Pat. No. 6,159,553 to Li et al., discloses the use of tantalum oxide (Ta₂O₅) as coating material on silicon nitride parts. A tantalum oxide coating of 2 to 500 microns in thickness can effectively protect the surface of silicon nitride parts from oxidation and reaction with water vapor at high temperatures. However, pure tantalum oxide coatings on Si-based parts have some limitations, including the following.

Ta₂O₅ undergoes a phase transformation from a low temperature phase (β-phase) to a high temperature phase (α-phase) at about 1350° C., which may cause cracking in the coating due to the change in volume which occurs during the phase transformation.

Ta₂O₅ is susceptible to grain growth at temperatures above 1200° C. Pronounced grain growth results in a large grain microstructure of up to about 10μ, which reduces the mechanical strength of the coating, induces high local residual stresses in the coating, and causes the coating to spall.

Ta₂O₅ has a coefficient of thermal expansion (CTE) of about 3×10⁻⁶° C.⁻¹, whereas silicon nitride has a CTE in the range of about 3-4×10⁻⁶° C.⁻¹ and silicon carbide (SiC) has a CTE in the range of 4-5×10⁻⁶° C.⁻¹. Since there is about 10 to 30% CTE mismatch between Ta₂O₅ and silicon nitride, and an even higher CTE mismatch between Ta₂O₅ and SiC, residual stresses will develop in the Ta₂O₅ coating on Si-based ceramics. These residual stresses can limit the service life of the coating.

Pure Ta₂O₅ coatings have a relatively low fracture toughness (probably from <1 to <3 MPa.m^{0.5}), which may adversely affect the mechanical integrity and the lifetime of the coating during service where there are foreign object impact and particulate erosion events.

Due to the above limitations, Ta₂O₅ coatings on Si-based ceramics may not provide adequate protection for turbine engine applications at temperatures of about 1300° C. or above, thousands of thermal cycles occur, and a coating lifetime greater than five thousand (5000) hours is required. Furthermore, the cost of Ta₂O₅ raw powder material is relatively high compared with that of most other high temperature ceramic oxide powders. Still further, the density of Ta₂O₅ is relatively high, so the weight of the coating may negatively affect the performance of the turbine machinery. It would be highly desirable to significantly improve the Ta₂O₅ coating to meet the stringent demands of advanced ceramic turbine engine applications, and to reduce the cost and weight of the coating.

As can be seen, there is a need for an environmental and thermal barrier coating for coating Si-based substrates, e.g., comprising Si₃N₄, wherein the coating protects the substrate from recession and thermal cycling at temperatures in the range of from about 1300 to 1550° C. There is a further need for an effective, low weight, and low cost environmental and thermal barrier coating for coating Si-based gas turbine engine components. There is also a need for a process for coating a silicon-based gas turbine engine component with an environmental and thermal barrier to provide an environmentally and thermally protected component. The present invention provides such coatings, components, and processes, as will be described in enabling detail hereinbelow.

### SUMMARY OF THE INVENTION

In one aspect of the present invention, there is provided an environmental and thermal barrier coating comprising a layer of a composition which comprises at least about 50 mole % AlTaO₄, and the balance comprising at least one metal oxide selected from the group consisting of Ta, Al, Cr, Hf, Ti, Zr, Mo, Nb, Ni, Sr, Mg, Si, and the rare earth elements including Sc, Y, and the lanthanide series of elements. The composition may have a coefficient of thermal expansion (CTE) in the range of from about 3.5×10⁻⁶° C.⁻¹ to 5×10⁻⁶° C.⁻¹, and a thickness in the range of from about 0.1 to 50 mils.

In another aspect of the present invention, an environmental and thermal barrier coating comprises a layer of a composition which comprises at least about 99 mole % AlTaO₄. The composition may be prepared by reacting a starting powder mixture comprising about 50 mole % Ta₂O₅ and about 50 mole % Al₂O₃. Such an environmental and thermal barrier coating may have a coefficient of thermal expansion (CTE) in the range of from about 4×10⁻⁶° C.⁻¹ to 5×10⁻⁶° C.⁻¹.

In still another aspect of the present invention, there is provided a thermally protected component comprising a substrate having a surface, and an environmental and thermal barrier coating disposed on the substrate surface. The environmental and thermal barrier coating may comprise at least about 50 mole % AlTaO₄, and the balance may consist essentially of Ta₂O₅ or Al₂O₃. Such an environmental and thermal barrier coating may be characterized by a coefficient of thermal expansion (CTE) in the range of from about 4×10⁻⁶° C.⁻¹ to 5×10⁶° C.⁻¹.

In yet another aspect of the present invention, a thermally protected component comprises a substrate having a surface, and an environmental and thermal barrier coating disposed on the substrate surface. The environmental and thermal barrier coating may comprise at least about 50 mole % AlTaO₄, and the balance may comprise at least one metal oxide including Ta, Al, Cr, Hf, Ti, Zr, Mo, Nb, Ni, Sr, Mg, Si, and the rare earth elements including Sc, Y, and the lanthanide series of elements.

In an additional aspect of the present invention, a method for preparing an environmentally and thermally protected component may include: providing a mixture of Ta₂O₅ (or a precursor thereof), and Al₂O₃ (or a precursor thereof); reacting the mixture to provide a reaction product comprising at least about 50 mole % AlTaO₄; and depositing a layer of the reaction product on a component surface to form an environmental and thermal barrier coating on the component surface.

In a further aspect of the present invention, a method for making an environmentally and thermally protected component includes: providing a composition comprising at least about 90 mole % AlTaO₄, and the balance consisting predominantly of a metal oxide such as Al₂O₃ or Ta₂O₅; providing a substrate having a surface to be coated; and depositing a layer of the composition on the substrate surface to form an environmental and thermal barrier coating on the substrate. Such a coating may have a coefficient of thermal expansion (CTE) in the range of from about 4×10⁻⁶° C.⁻¹ to 5×10⁻⁶° C.⁻¹, and a thickness in the range of from about 0.1 to 50 mils.

In another aspect of the present invention, there is provided a method for making an environmentally and thermally protected component including: providing a substrate to be coated with an environmental and thermal barrier coating. The substrate provided may comprise silicon carbide. Thereafter, the method further includes providing a composition comprising at least about 90 mole % AlTaO₄, and the balance comprising an oxide of an element selected from the group consisting of Ta, Al, Cr, Hf, Ti, Zr, Mo, Nb, Ni, Sr, Mg, Si, and the rare earth elements including Sc, Y, and the lanthanide series of elements. Thereafter, the method still further includes depositing a layer of the composition on the substrate surface to form the environmental and thermal barrier coating. Each of the substrate and the environmental and thermal barrier coating may have a coefficient of thermal expansion (CTE) in the range of from about 4×10⁻⁶° C.⁻¹ to 5×10⁻⁶° C.⁻¹.

These and other features, aspects and advantages of the present invention will become better understood with reference to the following drawings, description and claims.

### BRIEF DESCRIPTION OF THE DRAWINGS

FIG. 1 schematically represents a series of steps involved in a method for preparing an environmental and thermal barrier coating having an improved crystalline structure, according to one embodiment of the invention;

FIG. 2 schematically represents a series of steps involved in a second method for preparing an environmental and thermal barrier coating having an improved crystalline structure, according to another embodiment of the invention;

FIG. 3 schematically represents a component coated with an environmental and thermal barrier coating, according to the invention;

FIG. 4 schematically represents a series of steps involved in a method for preparing an environmentally and thermally protected component having an environmental and thermal barrier coating thereon, according to another embodiment of the invention; and

FIG. 5 is a scanning electron micrograph (SEM) showing the microstructure of an AlTaO₄ environmental and thermal barrier coating prepared according to one aspect of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides AlTaO₄-based coatings which can effectively protect substrates or components exposed to thermal cycling during service. Coatings of the invention are adapted to protect Si-based ceramic components from thermal damage during repeated thermal cycling to temperatures in the range of from about 1300 to 1550° C., and to protect such components from recession during service.

As an example, the present invention may be used to protect gas turbine engine components during exposure to service conditions. The environmental and thermal barrier coating compositions of the invention have a coefficient of thermal expansion (CTE) match with Si-based ceramic substrates, such as SiC- and Si3N4-based ceramics or composites. Coatings of the invention are therefore well adapted for coating Si-based substrates, e.g., gas turbine engine components comprising Si₃N₄, wherein the coating protects the substrate from recession and thermal cycling at temperatures in the range of from about 1300 to 1550° C.

The CTE of a 10 mole % Al₂O₃/90 mole % Ta₂O₅ alloy is about 3.5×10⁻⁶° C.⁻¹. As the alloy composition increases to 25 mole % Al₂O₃/75 mole % Ta₂O₅, the microstructure includes a mixture of Ta₂O₅—Al₂O₃ solid solution and AlTaO₄, and the CTE is about 4×10⁻⁶° C.⁻¹. Coatings comprising from about 10 mole % Al₂O₃/90 mole % Ta₂O₅ up to about 25 mole % Al₂O₃/75 mole % Ta₂O₅, having CTE values in the range of 3.5-4×10⁻⁶° C.⁻¹, may provide a suitable CTE match for coating Si₃N₄-based substrates. A starting mixture for forming a coating of the invention for coating SiC-based substrates (which may have a CTE in the range of 4-5×10⁻⁶° C.⁻¹), may comprise from about 25 to 50 mole % Al₂O₃. For a starting mixture having about 50 mole % Al₂O₃/50 mole % Ta₂O₅ the majority of the phase in the coating is AlTaO₄, and the CTE is about 5×10⁻⁶° C.⁻¹, thereby providing a good CTE match between the coating and the SiC-based substrate. In contrast, prior art coatings have CTE values too low to provide a good CTE match with SiC-based substrates.

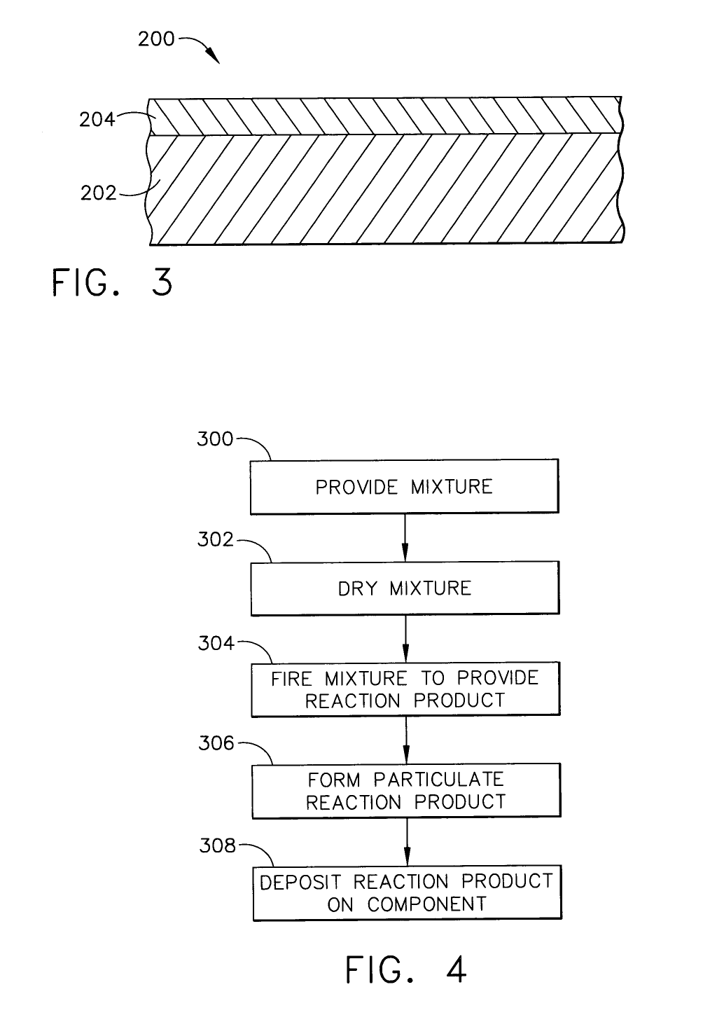

According to one aspect of the present invention, there is provided an environmental and thermal barrier coating (e.g., FIG. 3) comprising at least about 50 mole % of AlTaO₄. The balance in the coating may include at least one oxide of an element selected from the group consisting of Ta, Al, Cr, Hf, Ti, Zr, Mo, Nb, Ni, Sr, Mg, Si, and the rare earth elements including Sc, Y, and the lanthanide series of elements. In one embodiment, the invention provides a Si-based substrate or component coated with an environmental and thermal barrier coating (e.g., FIG. 3), wherein the coating comprises at least about 50 mole % of AlTaO₄.

The AlTaO₄-based coatings of the present invention prevent the loss of silica oxidation product formed on the surface of the Si-based substrate. The close CTE match between AlTaO₄ (ca. 5×10⁻⁶° C.⁻¹) and SiC-based substrates (ca. 4-5×10⁻⁶° C.⁻¹) makes the AlTaO₄-based materials of the present invention suitable coatings for SiC-based materials and composites. Besides the benefit of CTE match, AlTaO₄ further enjoys the benefits of having a stable crystalline structure at temperatures in the range of from about 1300 to 1550° C. (e.g., does not undergo β- to α-phase transformation at a temperature of 1550° C. (see Example 5)), a relatively low weight (e.g., a weight which is about 30% less than that of prior art Ta₂O₅ coatings), and a low production cost due to the low cost of Al₂O₃ powder employed as starting material. Since, coating compositions of the invention do not undergo β- to α-phase transformation at temperatures as high as 1550° C., such coatings may protect components exposed to at least 1550° C.

Generally, the AlTaO₄ in the coating of this invention may be prepared via the chemical reaction between Al₂O₃ and Ta₂O₅ powders, or their precursors, provided in a starting mixture, or may be formed from a commercially available AlTaO₄ powder. Various dopants or additives may be included in the starting mixture using either wet or dry mixing techniques in order to alter the CTE of the final product. Such dopants or additives may include one or more oxides, other compounds, or their precursors, of an element such as Hf, Ti, Zr, Mo, Nb, Ni, Sr, Mg, Si, Al, Cr, Ta, or the rare earth elements including Sc, Y, and the lanthanide series of elements. A coating composition prepared by firing such a mixture may be applied to a substrate to be coated using various deposition techniques well known in the art, such as plasma spray coating, dip coating, spray coating, sol-gel coating, chemical vapor deposition, physical vapor deposition, or electron beam physical vapor deposition.

The sintering property of Ta₂O₅ is improved by the inclusion of Al₂O₃ (alumina), as disclosed in commonly assigned co-pending U.S. Patent Application Publication No. 2002/0136835 A1, the disclosure of which is incorporated by reference herein in its entirety. Pressed pellets comprising alumina, e.g., containing from about 1.0 to 10 mole % of Al₂O₃, show higher density (e.g., as shown by less internal cracking of the Al₂O₃ containing pellets) as compared with pure Ta₂O₅ pellets sintered under the same conditions. For example, pure Ta₂O₅ pellets tend to fracture and disintegrate at room temperature, whereas the Al₂O₃ containing pellets remain intact. This improved sinterability is believed to be due to a reduction in the rate of Ta₂O₅ grain coarsening by the addition of Al₂O₃, and/or the enhancement of Ta ion lattice diffusion as the number of cation vacancies is increased by the diffusion kinetics due to the presence of Al ions.

The solid solubility of Al₂O₃ in Ta₂O₅ may be about 10 mole % at about 1500° C. Since α-Al₂O₃ has a CTE of about 8×10⁻⁶° C.⁻¹, the CTE of a 10 mole % Al₂O₃/90 mole % Ta₂O₅ alloy would be about 3.5×10⁻⁶° C.⁻¹, which is 10% higher than the CTE of pure Ta₂O₅ and closer to the CTE of silicon nitride. When the amount of Al₂O₃ in Ta₂O₅ exceeds about 10 mole %, a second phase having the formula of AlTaO₄ forms that has a CTE of about 5×10⁻⁴° C.⁻¹. As the alloy composition increases to 25 mole % Al₂O₃/75 mole % Ta₂O₅, the microstructure includes a mixture of Ta₂O₅—Al₂O₃ solid solution and AlTaO₄, and the CTE is about 4×10⁻⁶° C.⁻¹, which provides a good CTE match with SiC. If the Al₂O₃ concentration exceeds 25 mole %, the CTE of the coating may become too high for application on Si₃N₄ substrates. For SiC and its composites having a CTE in the range of 4-5×10⁻⁶ C⁻¹, the starting mixture for forming the coating composition may comprise up to about 50 mole % Al₂O₃, so that the majority of the phase in the coating is AlTaO₄, and there is a good CTE match between the coating and the substrate.

Coating compositions of the present invention exhibit low grain growth rate (e.g., having smaller grains, as shown by scanning electron microscopy, when Al₂O₃ is present with Ta₂O₅, as compared to Ta₂O₅ without Al₂O₃), good CTE match with Si-based substrates (as described hereinbelow), and high fracture toughness (e.g., as shown by difficulty in machining samples formed from the coating composition). The composition for forming the coating may comprise tantalum oxide (Ta₂O₅), or a mixture of Ta₂O₅ and Al₂O₃. Other oxides, compounds, or their precursors, of elements such as Cr, Hf, Si, Ln (rare earth elements including the entire lanthanum series and Y), Mg, Mo, Ni, Nb, Sr, Ti, and Zr may be added as dopants or additives. Such dopants may have some effect on the CTE of the resultant coating composition, mostly shifting it higher.

Additional additives (e.g., nitrides, carbides, borides, suicides) can be introduced to further inhibit grain growth, to modify the CTE, and reinforce tantalum oxide. By selecting particular dopants or combinations of dopants and additives, the above characteristics of grain growth rate, CTE/substrate match, and fracture toughness may be achieved.

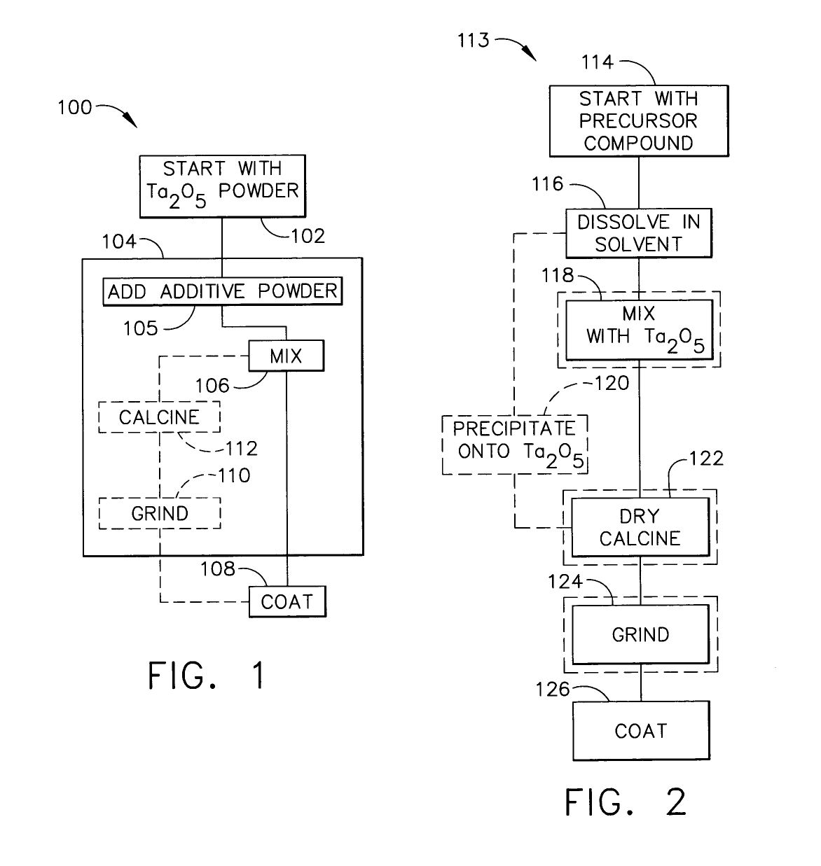

A variety of ceramic processing methods can be used to introduce and incorporate various dopants and additives into coatings of the present invention. As shown by the method 100 in FIG. 1, a process for forming a coating of the present invention may start with providing a commercially available powder, e.g., Ta₂O₅ powder, (step 102), to which a suitable amount (e.g., from about 1-50 mole %) of other oxides, additives, or their precursors, may be added in a step 105. The additives or their precursors may be in the form of powders which may be mixed (step 106) with the powder provided in step 102 to form a mixture 104. The mixing step 106 may be preformed either wet or dry.

After mixing (and drying, if wet mixing in a liquid medium is used) the mixture 104 may be coated on a substrate during a coating operation or step 108. Alternatively, the mixture may be subjected to a calcination step 112 in which the mixture is heat-treated, e.g., at a temperature up to about 1600° C., before performing the coating step 108. Optionally, a milling or grinding step 110 may be preformed after the calcination step 112 and before the coating step 108.

Referring to FIG. 2, an alternative method 113 of incorporating dopants or additives may use precursor compounds 114 (either solids or liquids) containing the dopant ions. The precursor compounds 114 may be dissolved in a solvent, such as water or an alcohol 116, mixed with Ta₂O₅ powder 118, and then precipitated onto the surface of the Ta₂O₅ particles 120. Alternatively, the Ta₂O₅ powder can be dispersed in the solvent first, and added with the precursors. After drying and an optional calcination step 122 and/or grinding step 124, the mixture 120 is then ready for a coating operation 126. Drying the mixture (when wet mixing is used), as well as steps 122 and 124 may be performed essentially as described with reference to FIG. 1.

The coating step 108 (FIG. 1) or 126 (FIG. 2) for applying the mixture (e.g., mixture 120, FIG. 2) created by either of the methods 100 or 113 may include plasma spraying, dip or spray coating, sol gel coating, and chemical vapor deposition (CVD). Moreover, the coating can be formed by sintering pressed ingots or similar materials at about 1350° C. for about 1 to 20 hours, and performing Physical Vapor Deposition, (PVD) or Electron Beam Physical Vapor Deposition (EB-PVD) methods (the latter method being well known in the field of thermal barrier coatings for super alloy turbine engine parts). Both PVD and EB-PVD coatings have the benefit of forming a uniform coating having a smooth surface, and allow strong bonding to the substrate, with uniform additive distribution.

FIG. 3 shows a component 200 formed in accordance with the present invention. Component 200 can include a substrate 202 which may comprise a Si-based material such as a SiC—SiC composite material. A layer of an environmental and thermal barrier coating 204 may be disposed on the outer surface of substrate 202 as described above. Coating 204 may be deposited on substrate 202 using a deposition process, such as EB-PVD, which allows the thickness of coating 204 to be accurately controlled. Typically, the thickness of coating 204 is in the range of from about 0.1 to 50 mils, usually from about 0.1 to 20 mils, and often from about 0.5 to 10 mils.

The coating 204 typically comprises at least about 50 mole % AlTaO₄. The coating 204 may be formed from a starting mixture comprising at least about 25 mole % Ta₂O₅ and at least about 25 mole % Al₂O₃. One or more dopants or additives may be included in the starting mixture, as described hereinabove. In some embodiments, coating 204 may comprise at least about 90 mole % AlTaO₄, and the balance may consist predominantly of Ta₂O₅ or Al₂O₃. In other embodiments, coating 204 may comprise more than 99 mole % AlTaO₄.

FIG. 4 schematically represents a series of steps involved in a method for preparing an environmentally and thermally protected component having an environmental and thermal barrier coating thereon, according to another embodiment of the invention. Step 300 involves providing a starting mixture. The starting mixture may comprise Al₂O₃ and Ta₂O₅. For example, the starting mixture may comprise equimolar quantities of Al₂O₃ and Ta₂O₅. The Ta₂O₅ ingredient of the starting mixture may be in the form of β-Ta₂O₅ powder. Typically, the starting powder mixture comprises at least about 25 mole % Al₂O₃ and at least about 25 mole % Ta₂O₅. In one embodiment, the starting mixture comprises at least about 45 mole % Al₂O₃ and at least about 45 mole % Ta₂O₅.

Lesser amounts of dopants or additives may be added to the starting powder mix, according to the desired properties of the environmental and thermal barrier coating to be formed from the starting mix. Such dopants or additives may comprise oxides, or other compounds, or their precursors, of elements including Al, Ta, Cr, Hf, Ti, Zr, Mo, Nb, Ni, Sr, Mg, Si, and the rare earth elements including Sc, Y, and the lanthanide series of elements. In one embodiment, the starting mixture may comprise about 50 mole % Al₂O₃ and about 50 mole % Ta2O5.

The composition of the starting mixture provided in step 300 may be selected in order to achieve a particular CTE for the environmental and thermal barrier coating product, to provide a CTE “match” with a particular substrate to be coated. That is to say, the composition of the starting mixture, and hence that of the environmental and thermal barrier coating, may be chosen according to the application, or the component to be coated to achieve a suitable CTE match between the component/substrate and the coating deposited thereon. For example, the substrate to be coated may have a CTE in the range of from about 4×10⁻⁶° C.⁻¹ to 5×10⁻⁶° C.⁻¹, and the environmental and thermal barrier coating to be applied thereon may have a CTE in the same range.

The starting mixture may be mixed with a suitable solvent, e.g., an alcohol such as isopropanol. After mixing, the starting mixture may be dried to remove solvent (step 302) prior to firing.

Step 304 involves firing the starting mixture at an elevated temperature to form a reaction product. The firing step 304 may be performed in a furnace in the presence of air. Typically, the firing temperature is in excess of 1000° C., usually in the range of from about 1200 to 1600° C., and often in the range of about 1500° C. The firing step may be continued until reaction between Al₂O₃ and Ta₂O₅ in the starting mixture is complete.

Step 306 involves forming a particulate reaction product. For example, the reaction product may be broken up mechanically, e.g., by grinding and the like, to form particles of the reaction product. In one embodiment, a particular size range of the particulate reaction product is selected preparatory to depositing a layer of environmental and thermal barrier coating on the surface of a substrate/component. For example, a particulate reaction product formed in step 306 may be sieved to provide particles having a size range of from about 2 to 200μ, and more typically in the range of from about 5 to 100μ.

Step 308 involves depositing the reaction product on the substrate/component to form an environmentally and thermally protected component having an environmental and thermal barrier coating disposed on the surface of the substrate/component. Techniques for depositing solid coatings on a surface are well known in the art. For example, the environmental and thermal barrier coating may be applied to the surface of the substrate/component by a process such as plasma spray coating, dip coating, spray coating, sol-gel coating, chemical vapor deposition, physical vapor deposition, or electron beam physical vapor deposition.

The environmental and thermal barrier coating deposited in step 308 typically comprises at least 50 mole % AlTaO₄, and may have a CTE in the range of 3.5×10⁻⁶° C.⁻¹ to 5×10⁻⁶° C.⁻¹. In some embodiments, the environmental and thermal barrier coating may comprise at least about 50 mole % AlTaO₄ and the balance may consist essentially of Al₂O₃ or Ta₂O₅.

In some embodiments, an environmental and thermal barrier coating of the invention may comprise at least about 90 mole % AlTaO₄. Such an environmental and thermal barrier coating may consist essentially of AlTaO₄ and a metal oxide, such as Al₂O₃ or Ta₂O₅. For example, an environmental and thermal barrier coating of the invention may comprise at least about 90 mole % AlTaO₄ and the balance may consist predominantly of Al₂O₃ or Ta₂O₅. In some embodiments, the Al₂O₃ or Ta₂O₅ component of the coating may be present in only trace amounts. An environmental and thermal barrier coating of the invention comprising about 90 mole % AlTaO₄ may have a CTE in the range of from about 4×10⁻⁶° C.⁻¹ to 5×10⁻⁶° C.⁻¹. Such coatings typically provide a good CTE match between the coating and SiC-based substrates. In certain embodiments, an environmental and thermal barrier coating of the invention may comprise more than 99 mole % AlTaO₄.

The CTE of the environmental and thermal barrier coating varies according to the mole % AlTaO₄ present therein. Thus, the mole % AlTaO₄ present in the environmental and thermal barrier coating may be varied according to the intended application, e.g., to obtain a suitable match between the CTE of the environmental and thermal barrier coating and the CTE of a substrate to be coated with the environmental and thermal barrier coating.

In an alternative approach to the method described with reference to FIG. 4, a mixture of Ta₂O₅ and Al₂O₃ applied to a component may react to form a coating comprising AlTaO₄ following exposure of the component to high temperatures during service conditions.

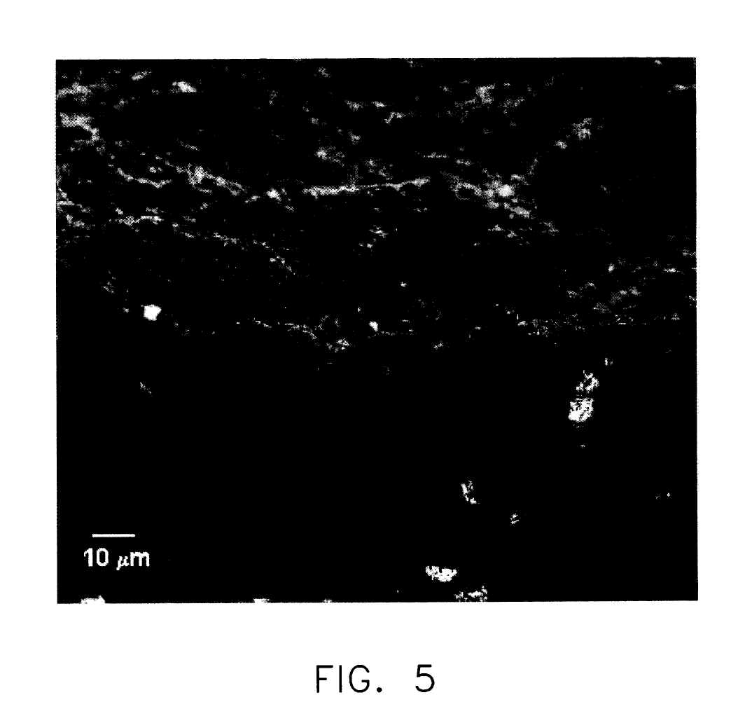

FIG. 5 is a scanning electron micrograph (SEM) showing the microstructure of a fractured surface of an AlTaO₄-based environmental and thermal barrier coating prepared generally according to the method of FIG. 4. The SEM of FIG. 5 shows a dense, fine-grained microstructure indicative of the superior mechanical and protective properties of the AlTaO₄-based coating. Such a coating also exhibits the desirable properties of CTE match with silicon composite substrates, and effectively protects the substrate from recession and repeated thermal cycling.

### EXAMPLES

### Example 1

Three compositions were prepared from starting mixtures having 1, 10, and 25 mole % Al₂O₃, respectively, as the additive to Ta₂O₅. For each composition, about 1 Kg of a commercial β-Ta₂O₅ powder was mixed with commercial Al₂O₃ powder in isopropanol in a milling jar for about 2 hours. After drying the mixture, the resultant powder was sieved to classify the particle size in the range of about 5 to 100 microns in preparation for plasma spray coating. If the particle size was too fine, a calcining process was included to coarsen the particles.

A coating of each of the above compositions was then applied to coupons of silicon nitride and SiC—SiC composite substrates by an air-plasma spraying process, as follows. The silicon nitride coupons had an as-sintered surface on which the plasma coating was applied. (Alternatively, a grit-blasted machine surface could have been utilized.) The coupons were degreased, and preheated to about 1000° C. by either a torch or furnace. The powder was then fed into a high velocity, high temperature plasma air flow. The ceramic powder became molten and subsequently was quenched and solidified onto the coupons. The coating thickness varied from about 2 to 10 mils. (i.e., from about 50 to 250 microns).

The coated samples were then subjected to a thermal cycling regime wherein each sample was held in a furnace at about 2400° F. (1315° C.) for about 30 minutes, and then quickly removed from the furnace and quenched to about 200° C. in a stream of blowing air. The silicon nitride coupons coated with all three compositions survived about 100 hours and 200 cycles without spalling. X-ray diffraction showed the Ta₂O₅ remained in the β-phase.

### Example 2

Four compositions were prepared from starting mixtures having 3, 4, 6, and 10 mole % La₂O₃, respectively, as the additive to Ta₂O₅. In each batch, about 1 Kg of a commercial β-Ta₂O₅ powder was mixed with commercial La₂O₃ powder in isopropanol in a milling jar for about 2 hours. After drying the mixture, the resultant powder was sieved to classify the particle size in the range of from about 5 to 100 microns preparatory to plasma spray coating.

Each composition was applied to coupons of silicon nitride and SiC—SiC composite substrates which were prepared and coated essentially as described in Example 1. The coating thickness varied from about 2 to 10 mils. The coated samples were then subjected to cyclic furnace testing essentially as described in Example 1.

The silicon nitride samples coated with La₂O₃ in the range of 3, 4, and 6 mole % survived more than 1000 hours and 2000 cycles at 1315° C. The SiC—SiC samples coated with compositions having La₂O₃ at 4, 6, and 10 mole % survived more than 2,000 hours and 4,000 cycles. SEM examination showed needle-shaped La₂O₃— Ta₂O₅ precipitates on the surface of the coating. X-ray diffraction showed the existence of a second phase containing La, possibly the La₂Ta₁₂O₃₃ phase according to the phase diagram. These needle-shaped second phases, which were distributed uniformly throughout the coating, increased the fracture toughness and mechanical strength of the coating. The second phase also increased the CTE of the coating, such that the CTE mismatch between the coating and the substrate was significantly reduced, resulting in improved coating life performance as shown by thermal cyclic testing.

### Example 3

A SiC—SiC coupon was coated with a composition prepared, from a starting mixture comprising about 50 mole % Al₂O₃ and 50 mole % Ta₂O₅, by a process essentially as described for Example 1. The coating prepared in this manner survived the thermal cycling regime of Example 1 (i.e., 1315° C. for about 30 minutes, and then quenched to about 200° C. in a stream of blowing air) for over 3000 hours without spalling. After the thermal cyclic testing, the coating was found to have been transformed to the AlTaO₄ phase, with some residual Ta₂O₅.

### Example 4

Coated silicon nitride coupons having coating compositions of 10 mole % Al₂O₃/90 mole % Ta₂O₅ survived thermal cycling at 1315° C. for 500 hours and 1000 cycles without spalling. X-ray diffraction of the thermally tested coating showed that the predominant phase in the coating was β-Ta₂O₅ with some AlTaO₄ phase.

### Example 5

Two coating compositions, 1 mole % Al₂O₃/99 mole % Ta₂O₅ and 5 mole % Al₂O₃/95 mole % Ta₂O₅, were heat-treated at 1450° C. for 2 hours. X-ray diffraction showed that the samples remained predominantly as β-Ta₂O₅ after the heat treatment. In contrast, pure β-Ta₂O₅ completely transformed to α-Ta₂O₅ after a heat treatment of 1 hour at 1450° C. Scanning electron microscopic (SEM) examination showed that the grain size for the 5 mole % Al₂O₃ coating composition fired at 1450° C. was significantly smaller than that of the pure Ta₂O₅ sample fired at the same temperature. The coating composition of 5 mole % Al₂O₃/95 mole % Ta₂O₅ was further heated at 1550° C. for 15 hours, and the Ta₂O₅ remained as the β-phase after the heat treatment.

### Example 6

Powders of two compositions, 7.5 mole % Al₂O₃/92.5 mole % Ta₂O₅ and 4 mole % La₂O₃/96 mole % Ta₂O₅, respectively, were pressed into cylindrically-shaped green parts and sintered at 1350° C. for 10 hours to form ingots for EB-PVD coating. Substrates of silicon nitride and SiC—SiC composites were loaded in a vacuum chamber and an electron beam was focused on an ingot of the material to be deposited. The substrate was preheated to 800-1200° C. to improve bonding with the deposited material. The electron bombardment resulted in high local heating on the coating material, which evaporated atomistically and condensed onto the substrate. Oxygen gas was then fed into the system to compensate for the loss of oxygen from Ta₂O₅ during the evaporation. The coating was chemically bonded to the substrate. The coated silicon nitride and SiC—SiC parts having a 50 micron thick coating survived the above described thermal cycling regime at 1315° C. for over 500 hours and 1000 cycles.

### Example 7

An AlTaO₄ powder compound was prepared by mixing 500 g of powder containing 50 mole % Al₂O₃ and 50 mole % Ta₂O₅ in isopropanol in a milling jar for about 2 hours, drying the mixture, and firing the resultant powder in a furnace in air at 1500° C. for 1 hour. X-ray diffraction confirmed the complete reaction between Al₂O₃ and Ta₂O₅ powders to form AlTaO₄. The reacted powder was broken down mechanically and sieved to classify the particle size to about 5 to 100 micron range in preparation for plasma spray coating (Example 8).

### Example 8

The resultant AlTaO₄ powder prepared according to Example 7 was plasma-sprayed on a SiC—SiC composite substrate of about 2 cm×2 cm×1 mm to form a coating about 5 mils in thickness. The coated substrate was tested by thermal cycling at 1315° C. under the conditions described in Example 1. The coating survived 100 hours and 200 cycles without spallation and effectively protected the SiC—SiC substrate.

### Example 9

An AlTaO₄ coating prepared according to the invention was examined by scanning electron microscopy to reveal a fined-grained microstructure (FIG. 5). This coating survived the thermal cycling regime described in Example 1 for more than 1600 cycles/800 hours at 1315° C.

It should be understood, of course, that the foregoing relates to preferred embodiments of the invention and that modifications may be made without departing from the spirit and scope of the invention as set forth in the following claims.

1. An environmental and thermal barrier coating, comprising:
a layer of a composition comprising at least about 50 mole % AlTaO₄, and the balance comprising at least one metal oxide selected from the group consisting of Ta, Al, Cr, Hf, Ti, Zr, Mo, Nb, Ni, Sr, Mg, Si, and the rare earth elements including Sc, Y, and the lanthanide series of elements, wherein said layer of said composition has a coefficient of thermal expansion (CTE) in the range of from about 3.5×10⁻⁴° C.⁻¹ to 5×10⁻⁶° C.⁻¹, and a thickness in the range of from about 0.1 to 50 mils.

2. The environmental and thermal barrier coating of claim 1, wherein said composition has a coefficient of thermal expansion (CTE) in the range of from about 4×10⁻⁶° C.⁻¹ to 5×10⁻⁶° C.⁻¹.

3. The environmental and thermal barrier coating of claim 1, wherein said layer of said composition has a thickness in the range of from about 0.1 to 20 mils.

4. The environmental and thermal barrier coating of claim 1, wherein said layer of said composition has a thickness in the range of from about 0.5 to 10 mils.

5. The environmental and thermal barrier coating of claim 1, wherein said composition comprises at least about 50 mole % AlTaO₄, and the balance consists essentially of Al₂O₃.

6. The environmental and thermal barrier coating of claim 1, wherein said composition comprises at least about 50 mole % AlTaO₄, and the balance consists essentially of Ta₂O₅.

7. The environmental and thermal barrier coating of claim 1, wherein said composition comprises at least about 90 mole % AlTaO₄.

8. The environmental and thermal barrier coating of claim 1, wherein said composition consists essentially of AlTaO₄.

9. The environmental and thermal barrier coating of claim 1, wherein said composition is prepared by reacting a starting powder mixture to form said AlTaO₄, said starting powder mixture comprising at least about 45 mole % Ta₂O₅ and at least about 45 mole % Al₂O₃.

10. The environmental and thermal barrier coating of claim 1, wherein said layer of said composition is deposited by an air plasma spray process.

11. An environmental and thermal barrier coating, comprising:
a layer of a composition comprising at least about 99 mole % AlTaO₄, wherein said environmental and thermal barrier coating has a coefficient of thermal expansion (CTE) in the range of from about 4×10⁻⁶° C.⁻¹ to 5×10⁻⁶° C.⁻¹.

12. A thermally protected component, comprising:
a substrate having a surface; and
an environmental and thermal barrier coating disposed on said surface of said substrate, wherein said environmental and thermal barrier coating comprises at least about 50 mole % AlTaO₄, and the balance consists essentially of Ta₂O₅ or Al₂O₃, and wherein said environmental and thermal barrier coating is characterized by a coefficient of thermal expansion (CTE) in the range of from about 4×10⁻⁶° C.⁻¹ to 5×10⁻⁶° C.⁻¹.

13. The thermally protected component of claim 12, wherein said substrate comprises a silicon-based ceramic or composite, said substrate having a coefficient of thermal expansion (CTE) in the range of from about 4×10⁻⁶° C.⁻¹ to 5×10⁻⁶° C.⁻¹.

14. A thermally protected component, comprising:
a substrate having a surface; and
an environmental and thermal barrier coating disposed on said surface of said substrate, wherein said environmental and thermal barrier coating comprises at least about 50 mole % AlTaO₄, and the balance comprises at least one metal oxide selected from the group consisting of Ta, Al, Cr, Hf, Ti, Zr, Mo, Nb, Ni, Sr, Mg, Si, and the rare earth elements including Sc, Y, and the lanthanide series of elements.

15. The thermally protected component of claim 14, wherein said at least one metal oxide comprises Al₂O₃ or Ta₂O₅.

16. The thermally protected component of claim 14, wherein said environmental and thermal barrier coating comprises at least about 90 mole % AlTaO₄.

17. The thermally protected component of claim 14, wherein said environmental and thermal barrier coating comprises greater than 99 mole % AlTaO₄.

18. The thermally protected component of claim 14, wherein said substrate comprises a silicon-based ceramic or composite.

19. The thermally protected component of claim 14, wherein said substrate comprises a SiC—SiC composite or a Si₃N₄ composite.

20. The thermally protected component of claim 14, wherein said environmental and thermal barrier coating has a stable crystalline structure at a temperature of about 1550° C.

21. The thermally protected component of claim 14, wherein said environmental and thermal barrier coating has a thickness in the range of from about 0.1 to 20 mils.

22. The thermally protected component of claim 14, wherein said substrate comprises a component of a gas turbine engine.

23. A method for preparing an environmentally and thermally protected component, the method comprising:
a) providing a mixture of Ta₂O₅, or a precursor thereof, and Al₂O₃, or a precursor thereof;
b) reacting said mixture to provide a reaction product comprising at least about 50 mole % AlTaO₄; and
c) depositing a layer of said reaction product on a surface of said component to form an environmental and thermal barrier coating disposed on said surface of said component.

24. The method of claim 23, wherein said mixture provided in said step a) comprises at least about 25 mole % Ta₂O₅ and at least about 25 mole % Al₂O₃.

25. The method of claim 23, wherein said environmental and thermal barrier coating has a coefficient of thermal expansion (CTE) in the range of from about 4×10⁻⁶° C.⁻¹ to 5×10⁻⁶° C.⁻¹.

26. The method of claim 23, wherein said step b) comprises heating said mixture in air at a temperature in the range of from about 1300 to 1600° C.

27. The method of claim 23, further comprising:
d) after said step b), providing particles of said reaction product, and wherein said step c) comprises depositing said layer of said reaction product on said surface of said component via a plasma spray process.

28. The method of claim 23, wherein said component comprises a silicon-based component of a gas turbine engine, and said environmental and thermal barrier coating has a thickness in the range of from about 0.1 to 50 mils.

29. The method of claim 23, wherein said environmental and thermal barrier coating formed in said step c) comprises at least about 90 mole % AlTaO₄, and the balance comprises at least one of Al₂O₃ and Ta₂O₅.

30. The method of claim 23, wherein said environmental and thermal barrier coating formed in said step c) consists essentially of AlTaO₄.

31. A method for making an environmentally and thermally protected component, comprising:
a) providing a composition comprising at least about 90 mole % AlTaO₄, and the balance consisting predominantly of a metal oxide selected from the group consisting of Al₂O₃ and Ta₂O₅;
b) providing a substrate having a surface to be coated; and
c) depositing a layer of said composition on a surface of said substrate to form an environmental and thermal barrier coating thereon, said environmental and thermal barrier coating having a coefficient of thermal expansion (CTE) in the range of from about 4×10⁻⁶° C.⁻¹ to 5×10⁻⁶° C.⁻¹, and a thickness in the range of from about 0.1 to 50 mils.

32. The method of claim 31, wherein said step a) comprises:
d) providing a mixture comprising at least about 45 mole % Ta₂O₅ and at least about 45 mole % Al₂O₃; and
e) heating said mixture to form said composition.

33. The method of claim 31, wherein said environmental and thermal barrier coating formed in said step c) comprises at least about 99 mole % AlTaO₄.

34. The method of claim 31, wherein said substrate comprises a silicon-based ceramic or composite having a coefficient of thermal expansion (CTE) in the range of from about 4×10⁻⁶° C.⁻¹ to 5×10⁻⁶° C.⁻¹.

35. The method of claim 31, wherein said component comprises a gas turbine engine component.

36. A method for making an environmentally and thermally protected component, comprising:
a) providing a substrate to be coated with an environmental and thermal barrier coating, said substrate comprising silicon carbide;
b) providing a composition comprising at least about 90 mole % AlTaO₄, and the balance comprising an oxide of an element selected from the group consisting of Ta, Al, Cr, Hf, Ti, Zr, Mo, Nb, Ni, Sr, Mg, Si, and the rare earth elements including Sc, Y, and the lanthanide series of elements; and
c) depositing a layer of said composition on a surface of said substrate to form said environmental and thermal barrier coating, each of said substrate and said environmental and thermal barrier coating having a coefficient of thermal expansion (CTE) in the range of from about 4×10⁻⁶° C.⁻¹ to 5×10⁻⁶ C⁻¹.

37. The method of claim 36, wherein said step b) comprises:
d) combining Ta₂O₅, or a precursor thereof, and Al₂O₃, or a precursor thereof, to form a mixture comprising at least about 45 mole % Ta₂O₅ and at least about 45 mole % Al₂O₃; and
e) heating said mixture to provide a reaction product comprising at least about 90 mole % AlTaO₄.

38. The method of claim 36, wherein said substrate comprises a gas turbine engine component.

39. An environmental and thermal barrier coating formed according to the method of claim 36.
